(19) United States
(12) Patent Application Publication
(10) Pub. No.: US 2026/0094419 A1
(43) Pub. Date: Apr. 2, 2026

(54) DEVICE AND METHOD FOR TRAINING A MACHINE LEARNING SYSTEM FOR FEATURE EXTRACTION IN DIGITAL IMAGES

(71) Applicant: Robert Bosch GmbH, Stuttgart (DE)

(72) Inventors: Levente Tamas, Cluj-Napoca (RO); Victor Domsa, Deva (RO)

(21) Appl. No.: 19/303,747

(22) Filed: Aug. 19, 2025

(30) Foreign Application Priority Data
Sep. 27, 2024 (DE) 10 2024 209 467.6

(51) Int. Cl. G06V 10/774; G06V 10/776

(52) U.S. Cl. CPC G06V 10/774; G06V 10/776

(57) ABSTRACT

A computer-implemented method of training a student machine learning system for feature extraction in digital images. The student machine learning system receives a digital image as input and provides different output data to the input digital image. Each of the different output data of the student machine learning system corresponds to the output data of one of at least two pretrained teacher machine learning systems for feature extraction in digital images. The teacher machine learning systems differ. The training includes receiving digital images as training data by the student machine learning system and by the at least two pretrained teacher machine learning systems, and training the student machine learning system by iteratively optimizing a loss function, which includes determining a deviation between the output data determined by the student machine learning system and the respective corresponding output data determined by the at least two teacher machine learning systems.

### CROSS REFERENCE

The present application claims the benefit under 35 U.S. C. § 119 of Germany Patent Application No. DE 10 2024 209 467.6 filed on Sep. 27, 2024, which is expressly incorporated herein by reference in its entirety.

### FIELD

The present invention relates to a computer implemented method for training a student machine learning system for feature extraction in digital images, a corresponding training system, a control system, a computer program, and a machine-readable storage medium.

### BACKGROUND INFORMATION

In autonomous driving, accurate vehicle localization is required. Visual odometry is a popular technique that contributes to such precise vehicle localization, e.g., by estimating a relative motion and by determining a position and orientation of the vehicle relative to a previous position in its environment, which can be implemented by using machine learning systems. Such corresponding machine learning systems, e.g., deep neural networks, may detect/determine visual features in digital images-captured by sensors fixed at the autonomous vehicle-, wherein the visual features may then be tracked across digital images captured at subsequent time steps.

In autonomous driving, embedded devices with, typically, dedicated functions such as sensor data procession tasks and/or control system tasks for managing steering/breaking/acceleration and/or navigation and localization tasks, are directly integrated within the vehicle's infrastructure. These devices may comprise machine learning systems that address at least parts of the aforementioned tasks.

To overcome the problem of limited computational resources on embedded devices, e.g., in vehicles, model compression of larger machine learning systems or knowledge distillation from larger to smaller machine learning systems may be used. In such configurations, the larger machine learning system may perform a specific task required for a function of the autonomous vehicle, however requiring too much computational resources to be executed on an embedded device. A smaller machine learning system may—after knowledge distillation or compression from the larger machine learning system—then perform/run the desired task on the embedded device. For use in the embedded device, the smaller machine learning system should then require fewer resources and less computational time.

### SUMMARY

According to a first aspect, the present invention relates to a computer-implemented method of training a student machine learning system for feature extraction in digital images. The feature extraction in digital images may be based on low level features (e.g., edges or pixel attributes for images). According to an example embodiment of the present invention, at least two pretrained teacher machine learning systems for feature extraction in digital images are provided. Each teacher machine learning system is configured to receive a digital image as input and to provide respective output data indicating the presence/existence of at least one (part of an) object and/or pattern in the digital image. In some, however non-limiting, cases, the output data may also indicate the location and/or extension of an object and/or pattern in the digital image. Accordingly, the output data of the teacher machine learning systems may comprise or may be given by the features extracted from the digital images. The teacher machine learning systems have different architectures. Furthermore, the respective output data of the teacher machine learning systems differ from each other. The respective output data of the teacher machine learning systems may comprise (e.g. local) features extracted from the input digital images that may be, e.g., used in a visual odometry system of an at least partly autonomous vehicle or robot.

The student machine learning system is configured to receive a digital image as input and to provide different output data to said input digital image, wherein each one of said different output data of the student machine learning system corresponds to the output data of one of the at least two teacher machine learning systems for the same input digital image. According to an example embodiment of the present invention, the method comprises the following steps. In a first step, the student machine learning system and the at least two pretrained teacher machine learning systems receive, respectively, the same digital images as training data for training of the student machine learning system. In a subsequent step, the student machine learning system is trained by iteratively optimizing a loss function, wherein the loss function comprises determining a deviation between the output data determined by the student machine learning system and the respective corresponding output data determined by the at least two teacher machine learning systems. The training of the student machine learning system comprises iteratively adjusting parameters of the student machine learning system, thereby iteratively optimizing the loss function.

The notion of a feature refers, within the context of the present application, to a measurable piece of information or characteristic extracted from the image data and which corresponds to a relevant visual aspect or pattern in a given digital image. Such feature may be designed to capture (salient) information for a specific task, such as, for instance, object recognition, image classification or visual odometry for autonomous driving. (Salient) information or characteristics may encompass broad range of possibilities, including edges, corners, textures, colors, object parts and/or even higher-level semantic concepts. Features are represented numerically. For instance, features may be represented by, potentially, but not necessarily, multidimensional vectors in a vector space. Other options include a two-dimensional representation, e.g., in terms of, but not limited to, a density map/grid/“feature map”, wherein each entry encodes some learned characteristic—in terms of a numeric value—from the input digital image. Such aforementioned numeric representation may allow for a comparison, an analysis and/or use as an input for a further machine learning system. For instance, a feature may comprise a depth information including an estimate of the distance of objects and/or distinctive points, like edges or corners, from a camera of a vehicle, that may, e.g., be reliably tracked across multiple/subsequent views, and which might be useful for understanding the 3D structure of the environment of the vehicle. A feature may also comprise numerical vectors representing, e.g., the appearance of image patches around keypoints, which may enable matching and correspondence finding in the example of visual odometry.

A relevant visual aspect or pattern in a given digital image may refer to (parts of) an object, which may be present in an environment of the vehicle or, alternatively, a robot, and which may be recorded by (a) sensor(s) of the vehicle/robot. Accordingly, with reference to an at least partly autonomous vehicle, the environment may comprise at least one of another vehicle, bike, or pedestrian. Additionally or alternatively, the environment may comprise at least one of a tree, a rock, a house, a bridge and/or a tunnel. A vehicle may be a car, van or truck. With respect to an exemplary embodiment of a robot, such robot may, e.g., be a household robot. In the case of a cleaning robot, the environment may, e.g., comprise objects typically present on or close to/nearby the floor in a room. The environment in case of household robots may generally comprise objects present in a household/house, such as chairs, tables, sofas, etc..

An architecture of a machine learning system may comprise the structure and components of the respective machine learning system, wherein the structure may specify how the components are ordered and/or connected to each other. For example, the architecture of a machine learning system may comprise the type and the respective number of layers of the machine learning system as well as the connections between layers and/or the type and number of (hyper-) parameters of the machine learning system.

With reference to the above described method of the present invention as well as further aspects and/or embodiments of the method of the present invention described below, an objective, among others, of the present invention may be said as to overcome the tight computational requirements of autonomous driving related to, e.g., vehicle localization or motion prediction using visual feature in real time on embedded devices. To address this issue, with reference to the above and below described aspects of the present invention, at least to trained deep neural networks with different architectures and different output formats, called teachers, may be used to train a smaller deep neural network, called student network, which may be smaller in terms if model parameters and which may processes the input digital image faster than any of the teacher networks. It may be noted that any data set comprising digital images for training a student machine learning system for feature extraction related to the application in autonomous driving scenarios may be used for the training of the student system, regardless of whether or not the data set has been used for training any of the teacher machine learning systems.

Knowledge distillation, as described in the present application, may be understood as a process where a smaller-computationally and/or with respect of required memory-, and hence more efficient student machine learning system learns to replicate the behavior or output of one or more larger, possibly slower or memory-costly teacher machine learning systems. This learning process involves training the student system with datasets, wherein the datasets are possibly/optionally, but not necessarily, annotated based on the outputs of the teacher systems, and using a loss function that may, e.g., optionally integrate the original loss functions of the teacher systems with optionally additional loss functions measuring the discrepancies between the teachers' outputs and the student's outputs. The goal, i.e., training objective, for the student system may be to achieve similar performance to the teacher systems but with fewer parameters and faster execution speed, making it suitable for applications requiring high efficiency but rather low computational resources, such as on embedded devices in an autonomously driving vehicle.

Advantageously, the above and in the following described method of the present invention leverages the diverse feature extraction capabilities of multiple pretrained “teacher” models with different architectures. By training a single “student” model to mimic the outputs of these teachers, the method aims to create a more robust and generalized feature extractor. This approach potentially surpasses the performance of any individual teacher model by combining their strengths and mitigating their individual weaknesses.

It is worth to stress that the method provided herein according to the present invention is neither limited to a specific type of a neural network/machine learning system nor to specific features.

Preferably, the student machine learning system has an architecture differing from any of the teacher machine learning systems and/or wherein the student machine learning systems has a reduced architecture as compared to at least one of the teacher machine learning systems, wherein the reduced architecture of the student machine learning system comprises a reduced number of layers and/or connections between layers and/or a reduced number of parameters of the student machine learning system.

The time span elapsed from receiving the input data to outputting the output data-which may then be, optionally, further processed—may be smaller for the student compared to the respective teacher machine learning system. For example, the aforementioned time span may be significantly smaller, e.g., half as long or less. In other words, the execution speed of the student machine learning system in producing output data (once it receives input data) may be faster than the corresponding speed of the respective teacher system. For example, the execution speed may be twice as fast as the execution speed of the teacher machine learning system which produces the same kind of output data.

It may further be noted that the number of parameters of the student machine learning system may be a percentage of the number of parameters in at least one of the teacher machine learning systems.

Advantageously, by having a different, potentially reduced, architecture compared to its teachers, the student machine learning system may achieve faster inference and require less computational resources while still benefiting from the knowledge acquired from the multiple teacher models. This may make the student model more suitable for deployment in resource-constrained environments like mobile or embedded systems in vehicles/robots.

Preferably, according to an example embodiment of the present invention, the teacher machine learning systems have been trained using different training methods from each other, wherein a training method is defined by at least one of training data, loss function, and/or training hyperparameters.

Advantageously, by learning from teacher machine learning systems trained with diverse methods and datasets and/or with differing architectures and/or loss functions, the student machine learning system may potentially capture a broader range of feature representations, leading to improved generalization and robustness beyond what might be possible with a single training methodology.

Preferably, according to an example embodiment of the present invention, the respective output data of the teacher machine learning systems differ in terms of at least one of semantic content, data representation and/or spatial resolution. A semantic content may, in the given context, be given by, e.g., information about the dynamics of objects in a given image in one output data and information about the reliability of the region, in which the objects are located in the respective image, for visual odometry in another output data. A data representation may be given by, e.g., a heat map, an image with semantic segmentation (i.e., a semantic segmented image), an image with bounding boxes with annotations, wherein annotations may, for instance, be given by class labels, and/or a scene categorization. A data representation may also refer to/comprise a binary or multi-channel output type. A spatial resolution may refer, e.g., to a high and a low resolution. E.g., as a non-limiting example, one teacher machine learning system may provide a high-resolution heat map or semantic segmentation and another teacher machine learning system may provide a low-resolution heat map or semantic segmentation.

Advantageously, by exposing the student machine learning system to outputs of the at least two teacher machine learning systems with respective varying semantic content, data representations, or spatial resolutions, may encourage the student system to learn richer and more comprehensive feature representation, potentially improving its ability to generalize across different situations, e.g. in an autonomous driving scenario.

Preferably, according to an example embodiment of the present invention, the training data may be obtained by providing a set of digital images, wherein each of the respective pre-trained teacher machine learning systems may receives the digital images in the provided set as inputs. Further, each of the teacher machine learning systems may determine a respective output to each of the provided input digital images. The training data for the student machine learning system may then be given by the set of digital images together with the respective corresponding outputs determined by each of the teacher machine learning systems.

Advantageously, a training data set for training of the student machine learning system may then be obtained in an easy and cheap manner, without having to rely on, e.g., publicly available annotated data sets.

Preferably, according to an example embodiment of the present invention, the loss function may comprise additional terms, wherein the additional terms may comprise at least one of the loss functions used in the training of at least one of the teacher machine learning systems, respectively.

Preferably, according to an example embodiment of the present invention, the student machine learning system may further be configured to determine a control signal for a vehicle by further processing the output data, and wherein the control signal may be used to control an actuator. The actuator may be configured to control a break, a steering angle and/or a velocity of the vehicle.

According to a further aspect, the present invention relates to a training system comprising a processor configured to perform a method of training of the present invention as described herein.

According to a further aspect, the present invention relates to a control system, which is configured to determine a control signal by carrying out method steps described above, wherein the control signal is configured to control an actuator.

According to a further aspect, the present invention relates to a computer program with machine-readable instructions, which, when executed on one or several computer(s), cause the computer(s) to perform one of the computer-implemented methods described above and below. Furthermore, according to another aspect, the present invention relates to a machine-readable storage medium, on which the above computer program is stored.

Embodiments of the present invention will be discussed in more detail with reference to the figures.

### BRIEF DESCRIPTION OF THE DRAWINGS

FIG. 1 shows a flow chart of an exemplary embodiment of the present invention.

FIG. 2 shows a flow chart of an exemplary embodiment of the present invention.

FIG. 3 shows a training system for training a student machine learning system for feature extraction in digital images, according to an example embodiment of the present invention.

### DETAILED DESCRIPTION OF EXAMPLE EMBODIMENTS

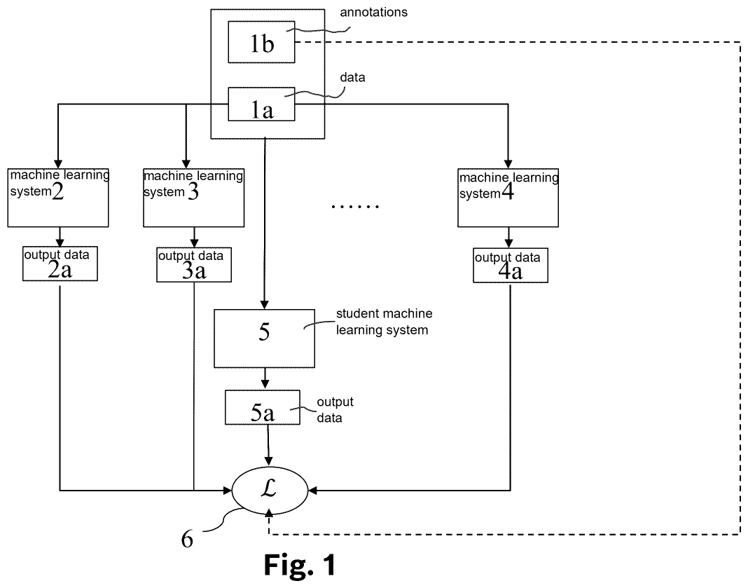

FIG. 1 shows an exemplary embodiment of the present invention, involving distilling the knowledge from at least two, 2, 3, or more, 4, (generally, a natural number of; here the dots in the FIG. 1 indicate that more than two, and more than three teacher machine learning systems may be comprised) different teacher machine learning systems into a smaller (as regards the number of, e.g., the parameters and/or the memory storage needed) and computationally faster student machine learning system 5. Teacher and student machine learning system(s) may be neural networks. The teachers may differ regarding backbone architecture, outputs, and/or training methods (comprising the use of differing loss functions, annotations, etc.). The training goal is for the student machine learning system 5 to reproduce the outputs of the teacher machine learning systems 2, 3, 4 with minimal loss in validity, regardless of the backbone architecture used for the student machine learning system. The loss function 6 used to distill the knowledge from the teacher machine learning systems 2, 3, 4 to the student machine learning system 5 shall match the corresponding output of the student machine learning system 5 to the outputs of each teacher machine learning system and may optionally contain a loss function suitable for the dataset's 1 ground truth. The teacher models 2, 3, 4 may have unrelated backbone architectures and different outputs from one another. Due to the difference in output layers, the training methods for the teacher machine learning system (also referred herein to as: models) may also differ, with each teacher machine learning system having its own dataset, loss functions, and particularities. The teachers should, however, be similar in the overall task that they shall perform. Training data 1 may comprise, e.g., data 1a, wherein data 1a may be digital image data and data 1a may be provided as input to the machine learning systems 2, 3, 4, 5. Training data 1 may additionally comprise annotations 1b to each of the data 1a. Annotations 1b may comprise labels or classifications of the data 1a. Annotations 1b may comprise desired output data to be determined by the trained (student or teacher) machine learning system. The machine learning systems 2, 3, 4, and 5 may process the input data 1a and determine corresponding output data 2a, 3a, 4a, and 5a, respectively. These output data are provided as an input to loss function 6. Optionally, loss function 6 may also receive data 1b. Loss function 6 may comprise different terms for determining the difference between outputs of the student machine learning system with respect to the respective teacher machine learning systems. In addition, loss function 6 may comprise a “ground truth” term for determining the difference between the student system's output data and the respective annotations 1b.

As a non-limiting example, comprising the case of two teacher machine learning systems, R2D2 (arxiv.org/abs/1906.06195) and PixLoc (arxiv.org/abs/2103.09213) may be chosen as teacher machine learning systems, thereby providing two feature extractors and descriptors that may be used for visual odometry, structure from motion, SLAM, and visual re-localization. The R2D2 model is explicitly trained to find sparse, repeatable, and reliable keypoint features from matches created synthetically and matches found by the more accurate optical flow algorithms. The backbone of R2D2 is based on L2-Net, which is used for image patch description.

The descriptors can be matched in Euclidean space using the L2 distance. The backbone inputs an image (patch) and outputs its descriptor. In R2D2, the L2-Net is modified by replacing stride 2 in the convolution layers with dilated convolution layers to preserve the input resolution in all layers. R2D2 has three output heads: two of them are heatmaps with size H×W and are called reliability and repeatability maps, while the third head outputs a D-dimensional map with size H×W×D, which represents the descriptors of each pixel. Each of these heads is trained using a specific loss function. The loss function of repeatability is a combination of co-similarity loss between heatmaps of local patches and a loss that maximizes the peakiness of the patches, as can be seen in the following equations:

$${L}_{cosim} ( I , {I}^{′} , U ) = 1 - \frac{1}{\vert P \vert} {\sum }_{p ∈ P} cosim ( S [ p ] , {S}_{U}^{′} [ p ] ) \qquad ( 1 )$$

$${L}_{peaky} ( I ) = 1 - \frac{1}{\vert P \vert} {\sum }_{p ∈ P} ( {max}_{( i , j ) ∈ p} {S}_{i , j} - {mean}_{( i , j ) ∈ p} {S}_{i , j} ) \qquad ( 2 )$$

$${L}_{rep} ( I , {I}^{′} , U ) = {L}_{cosim} ( I , {I}^{′} , U ) + λ ( {L}_{peaky} ( I ) + {L}_{peaky} ( {I}^{′} ) ) \qquad ( 3 )$$

Here, I and I′ are two images seeing the same scene, U∈R^{(H×W×2)} is the ground truth containing the correspondences between the images, P is the set of all patches p in [1 . . . . W]×[1 . . . . H], S is the repeatability map, S[p] is the repeatability map extracted for a patch p of size N×N from image I, S′_{U}[p] is the corresponding repeatability map of the patch p from the image I′ according to the ground truth U, and A is a weighting hyperparameter. The cosine similarity loss L_{cosim} aims to make the heatmaps of the corresponding matches identical. Since the image may usually suffer from occlusions, warps, and other artifacts that cannot be mitigated, the loss function is applied locally, by taking into consideration only patches p∈P from the images. A trivial solution to the minimization of the L_{cosim} loss is to take S and S′_{U} to be constant. In order to avoid this, the peakiness loss L_{peaky} is employed. To train the reliability heatmap and the descriptors of the machine learning system, the Average-Precision (AP) for all image patches is used. The descriptors are dense, in the sense that each pixel (i,j) will have a corresponding descriptor X_{i,j}∈ [symbol] ^{D}, where D is the size of the descriptor. Furthermore, the reliability map is defined as R∈ [symbol] ^{H×W} where R_{i,j}∈[0,1]. The AP is computed between a patch of size M around a pixel location (i,j) from the first image and the patch size around the ground-truth correspondence from U, as can be seen in Eq. (4):

$${L}_{AP κ} ( i , j ) = 1 - [ AP ( i , j ) {R}_{i , j} + κ ( 1 - {R}_{i , j} ) ] \qquad ( 4 )$$

Here κ∈[0,1] is a hyperparameter that sets the minimum expected AP per patch. In this context, ideally, R_{i,j}=0 if AP(i,j)<κ and R_{i,j}=1 otherwise. In practice, R_{i,j} ∈[0,1]. The keypoint location is found by finding the local maxima of both the reliability and repeatability heatmaps. The training is done using three data sources: random web images where pixel correspondences are synthetically built by applying homographies and color jittering, images from public landmarks datasets, such as the Aachen dataset, arxiv.org/abs/1707.09092, with the same augmentations as for the web images and with correspondences found using an optical flow algorithm.

Given a sparse 3D model of the environment created from some reference images, PixLoc can accurately localize a set of query images. A convolutional neural network (CNN) detects local features, while the actual localization is left to established classical geometric optimization algorithms. The CNN learns better features from the estimated camera poses directly, as seen in Eq. (5):

$${L}_{pix} = \frac{1}{L} {\sum }_{l} {\sum }_{i} {‖ \prod ( {R}_{l} {P}_{i} + {t}_{l} ) - \prod ( \overline{R} {P}_{i} + \overline{t} ) ‖}_{γ} \qquad ( 5 )$$

Here, l∈L represents the feature level depth in the CNN from which the local features are extracted, (Rₗ,tₗ) is the pose estimated from each feature level, (R̅,t̅) is the ground truth pose, Π computes the projection of the 3D point in the image, and γ denotes the Huber cost. In this manner, the CNN natively learns to ignore regions unsuitable for camera pose estimation (such as highly repetitive textures and dynamic objects). The backbone of the CNN is based on a VGG19 encoder, arxiv.org/abs/1409.1556, pretrained on ImageNet. The CNN outputs three feature maps with strides 1, 4, and 16 and their corresponding confidence map. The confidence and feature maps at each stride directly estimate the pose. The dimension of the input is reduced between the layers of the CNN to encode richer semantic information. The loss function directly compares the ground truth pose with the pose estimated using the local features from the CNN. For experiments, one CNN was trained on the MegaDepth dataset, which is a collection of images containing crowd-sourced popular landmarks, and another on the Extended CMU Seasons dataset, which consists of images taken from cameras mounted on a car that travels in a city during different seasons and weather types.

The student machine learning system may have the backbone structure of either teacher, with varied parameters, or another backbone altogether. In experiments related to aspects of the method described above and herein, it could be shown that better results may be achieved with the student machine learning system than with the default R2D2 model for the re-localization task using a student machine learning system with a backbone structure like R2D2 but with half the parameters. The student network has all the outputs from the base R2D2 model, with the addition of the “confidence” heatmap from PixLoc. With a training strategy similar to knowledge distillation, the new confidence map may successfully learn to ignore dynamic objects like cars and pedestrians. The PixLoc teacher confidence map may also include information about the repeatable textures in the environment. While this information is, to some extent, captured in the R2D2 reliability and repeatability maps, the explicit addition of the confidence map may make the student features easier to match and filter from dynamic objects or objects that can easily change from one run to another (such as cars, pedestrians, leaves of trees). Furthermore, a high-quality confidence map may be obtained from the student network without reducing the dimensionality of the features from one layer to another, as is done in the base PixLoc model. The training of the student machine learning system (also referred to as: student model herein) may involve using output features from both teacher models. The dataset on which the training in experiments may be done may be a previously used dataset for training either of the teachers or may be a new dataset (not used in training of the teacher models) with/without annotations. The training of the student then further mainly focuses on aligning the outputs of the two teachers for each particular output layer with the outputs of the student network for all common output layers, as in Eq. (6) below, where H_{teacher} represents the heatmaps of the teacher models, H_{student} represents the corresponding heatmap of the student model, and L_{model} is an optional loss function that corresponds to the student model architecture. To compare the teachers' heatmaps with the students' heatmaps, the L2 norm between the heatmaps may be computed.

$${L}_{distil} = \sum {‖ {H}_{teac her} - {H}_{student} ‖}_{2}^{2} + {L}_{model} \qquad ( 6 )$$

In some experiments in context of the embodiment described here, a student network with the backbone like R2D2 but with half the number of parameters has been used. The weights were initialized randomly from a Gaussian distribution. A “confidence” map and reliability and repeatability maps in the student model were introduced. For training, the loss function Laistu from Eq. (6) was added and the public Aachen dataset along with a dataset composed of random web images was used. The Aachen dataset was labeled with three different techniques: using an optical flow algorithm, a style transfer algorithm, arxiv.org/abs/1802.06474, to convert day images into night images, and applying random transformations, such as homographies and color jittering, to the pictures. The data for the random web images were annotated using only the random transformations. One possible implementation for the teacher machine learning systems may consist of the teacher networks being the base R2D2 model pretrained on the same datasets, while the other teacher being a PixLoc model trained on the Extended-CMU Seasons dataset. In the described exemplary embodiment, the student model was validated on the HPatches dataset.

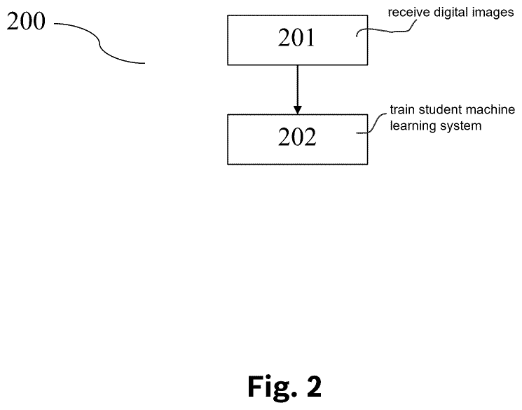

FIG. 2 shows a flowchart depicting an exemplary embodiment of a computer implemented method 200 of training a student machine learning system (5) for feature extraction in digital images 1a. At least two pretrained teacher machine learning systems for feature extraction in digital images are provided. Each teacher machine learning system is configured to receive a digital image as input and to provide respective output data indicating the presence of at least one object and/or pattern in the digital image. The teacher machine learning systems have different architectures, wherein the respective output data of the teacher machine learning systems differ from each other, wherein the student machine learning system is configured to receive a digital image as input and to provide different output data to said input digital image, wherein each one of said different output data of the student machine learning system corresponds to the output data of one of the at least two teacher machine learning systems for the input digital image. The exemplary embodiment of method 200 may comprise the following steps: In step 201, digital images are received as training data by the student machine learning system and by the at least two pretrained teacher machine learning systems. In a next method step 202, the student machine learning system is trained by iteratively optimizing a loss function. The loss function may comprise determining a deviation between the output data determined by the student machine learning system and the respective corresponding output data determined by the at least two teacher machine learning systems.

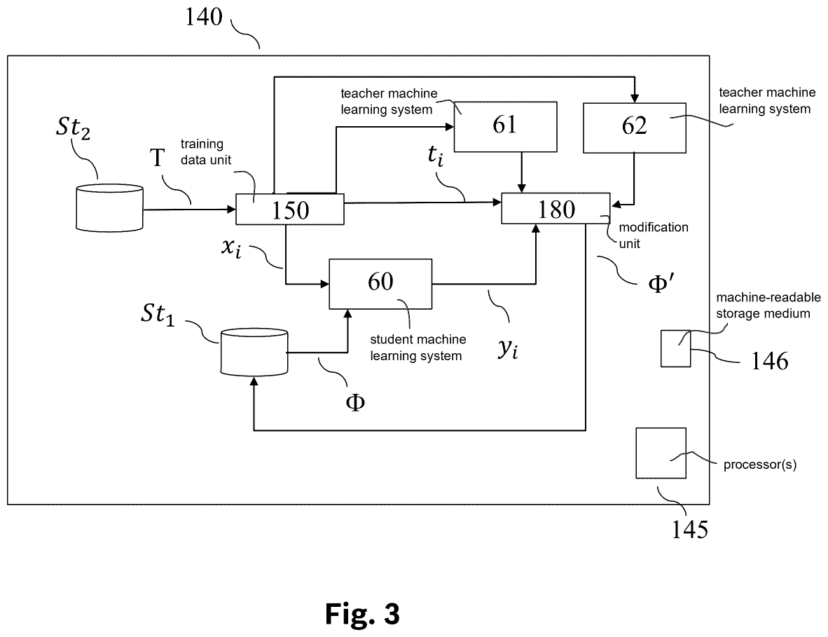

FIG. 3 shows another embodiment of a training system 140 for training student machine learning system 60 by means of a training data set T and at least two teacher machine learning systems 61, 62. The training data set T comprises a plurality of input signals xᵢ, each input signal representing digital image data, which are used for training the student machine learning system 60, wherein the training data set T further comprises, for each input signal xᵢ, a desired output signal tᵢ which corresponds to the input signal xᵢ. The desired output signal may be given by/characterize a classification of the digital image comprised in the input signal xᵢ. In addition to the student machine learning system 60, at least two (optionally more, not depicted in FIG. 3) pre-trained teacher machine learning systems 61, 62 are provided. The outputs of the teacher machine learning systems may differ from each other. The desired output signal may, for each input signal, comprise several different output signals, wherein the type/format of each of the output signals may correspond to one of the respective outputs of the teacher machine learning systems.

For training, a training data unit 150 accesses a computer-implemented database St₂, the database Ste providing the training data set T. The training data unit 150 determines from the training data set T preferably randomly at least one input signal xᵢ and optionally the desired output signal tᵢ corresponding to the input signal xᵢ and transmits the input signal xᵢ to the student machine learning system 60 as well as to the pre-trained teacher machine learning systems 61, 62. The machine learning systems 60, 61, 62 determine output signal yᵢ and y′ᵢ,y″ᵢ based on the input signal xᵢ. The output signal yᵢ of the student machine learning system may comprise several different output data to said input signal, wherein each one of said different output data of the student machine learning system corresponds to the output data of one of the at least two teacher machine learning systems for the input digital image.

The determined output signals, yᵢ, y′ᵢ and y″ᵢ, and, optionally, the desired output signal tᵢ are transmitted to a modification unit 180.

Based on the determined output signals of the student machine learning system, yᵢ, and the outputs of the teacher machine learning systems, y′ᵢ,y″ᵢ, and, optionally, the desired output signal tᵢ, modification unit 180 then determines new parameters d′ for the student machine learning system 60. For this purpose, modification unit 180 compares the determined output signals of the teacher machine learning systems and the determined output signals of the student machine learning system using a loss function. Optionally, the outputs of the student machine learning system are also compared to the desired output signals tᵢ using an additional term in the loss function. The loss function determines a first loss value that characterizes how far the determined output signals yᵢ of the student machine learning system deviate from the respective outputs of the teacher machine learning systems and, optionally, from the desired output signals tᵢ.

Modification unit 180 determines new parameters Φ′ for the student machine learning system based on the first loss value.

In other preferred embodiments, the described training is repeated iteratively for a predefined number of iteration steps or repeated iteratively until the first loss value falls below a predefined threshold value. Alternatively, or additionally, it is also possible that the training is terminated when an average first loss value with respect to a test or validation data set falls below a predefined threshold value. In at least one of the iterations the new parameters Φ′ determined in a previous iteration are used as parameters Φ of the student machine learning system 60.

Furthermore, the training system 140 may comprise at least one processor 145 and at least one machine-readable storage medium 146 containing instructions which, when executed by the processor 145, cause the training system 140 to execute a training method according to one of the aspects of the present invention.

The term “computer” may be understood as covering any devices for the processing of pre-defined calculation rules. These calculation rules can be in the form of software, hardware or a mixture of software and hardware.

What is claimed is:

1. A computer-implemented method of training a student machine learning system for feature extraction from digital images, wherein at least two pretrained teacher machine learning systems for feature extraction from digital images are provided, wherein each teacher machine learning system is configured to receive a digital image as input and to provide respective output data indicating presence of at least one object and/or pattern in the digital image, wherein the teacher machine learning systems have different architectures, wherein the respective output data of the teacher machine learning systems differ from each other, wherein the student machine learning system is configured to receive a digital image as input and to provide different output data to said input digital image, wherein each one of the different output data of the student machine learning system corresponds to output data of one of the at least two teacher machine learning systems for the input digital image, the method comprising the following steps:
receiving digital images as training data by the student machine learning system and by the at least two pretrained teacher machine learning systems; and
training the student machine learning system by iteratively optimizing a loss function, wherein the loss function includes determining a deviation between output data determined by the student machine learning system and respective corresponding output data determined by the at least two teacher machine learning systems.

2. The method according to claim 1, wherein: (i) the student machine learning system has an architecture differing from any of the teacher machine learning systems and/or (ii) the student machine learning systems has a reduced architecture as compared to at least one of the teacher machine learning systems, wherein the reduced architecture of the student machine learning system includes a reduced number of layers and/or connections between layers and/or a reduced number of parameters of the student machine learning system.

3. The method according to claim 1, wherein the teacher machine learning systems have been trained using different training methods from each other, wherein a training method is defined by at least one of training data and/or loss function and/or training hyperparameters.

4. The method according to claim 3, wherein the respective output data of the teacher machine learning systems differ in terms of at least one of semantic content and/or data representation and/or spatial resolution.

5. The method according to claim 1, wherein the training data are obtained by providing a set of digital images, wherein each of the respective pre-trained teacher machine learning systems receives the digital images in the provided set as inputs, wherein the teacher machine learning systems determine a respective output to each of the provided input digital images, and wherein the training data for the student machine learning system are given by the set of digital images together with the respective corresponding outputs determined by each of the teacher machine learning systems.

6. The method according to claim 1, wherein the loss function includes additional terms, wherein the additional terms include at least one of the loss functions used in the training of at least one of the teacher machine learning systems, respectively.

7. The method according to claim 1, wherein the student machine learning system is further configured to determine a control signal for a vehicle by further processing the output data, and wherein the control signal is used to control an actuator.

8. A training system, comprising:
a processor configured to train a student machine learning system for feature extraction from digital images,
wherein at least two pretrained teacher machine learning systems for feature extraction from digital images are provided, wherein each teacher machine learning system is configured to receive a digital image as input and to provide respective output data indicating presence of at least one object and/or pattern in the digital image, wherein the teacher machine learning systems have different architectures, wherein the respective output data of the teacher machine learning systems differ from each other, wherein the student machine learning system is configured to receive a digital image as input and to provide different output data to said input digital image, wherein each one of the different output data of the student machine learning system corresponds to output data of one of the at least two teacher machine learning systems for the input digital image, the processor being configured to:
receive digital images as training data by the student machine learning system and by the at least two pretrained teacher machine learning systems; and
train the student machine learning system by iteratively optimizing a loss function, wherein the loss function includes determining a deviation between output data determined by the student machine learning system and respective corresponding output data determined by the at least two teacher machine learning systems.

9. A control system, configured to:
determine, using a trained student machine learning system, a control signal, wherein the control signal is used to control an actuator of the vehicle;
wherein the student machine learning system is trained for feature extraction from digital images, wherein at least two pretrained teacher machine learning systems for feature extraction from digital images are provided for the training, wherein each teacher machine learning system is configured to receive a digital image as input and to provide respective output data indicating presence of at least one object and/or pattern in the digital image, wherein the teacher machine learning systems have different architectures, wherein the respective output data of the teacher machine learning systems differ from each other, wherein the student machine learning system is configured to receive a digital image as input and to provide different output data to said input digital image, wherein each one of the different output data of the student machine learning system corresponds to output data of one of the at least two teacher machine learning systems for the input digital image, the student machine learning system is trained by:
receiving digital images as training data by the student machine learning system and by the at least two pretrained teacher machine learning systems; and
training the student machine learning system by iteratively optimizing a loss function, wherein the loss function includes determining a deviation between output data determined by the student machine learning system and respective corresponding output data determined by the at least two teacher machine learning systems.

10. A non-transitory computer-readable storage medium on which is stored a computer program including instructions for training a student machine learning system for feature extraction from digital images, wherein at least two pretrained teacher machine learning systems for feature extraction from digital images are provided, wherein each teacher machine learning system is configured to receive a digital image as input and to provide respective output data indicating presence of at least one object and/or pattern in the digital image, wherein the teacher machine learning systems have different architectures, wherein the respective output data of the teacher machine learning systems differ from each other, wherein the student machine learning system is configured to receive a digital image as input and to provide different output data to said input digital image, wherein each one of the different output data of the student machine learning system corresponds to output data of one of the at least two teacher machine learning systems for the input digital image, the instructions, when execute by a computer, causing the computer to perform the following steps:
receiving digital images as training data by the student machine learning system and by the at least two pretrained teacher machine learning systems; and
training the student machine learning system by iteratively optimizing a loss function, wherein the loss function includes determining a deviation between output data determined by the student machine learning system and respective corresponding output data determined by the at least two teacher machine learning systems.
